(19) United States
(12) Patent Application Publication
(10) Pub. No.: US 2025/0210953 A1
(43) Pub. Date: Jun. 26, 2025

(54) BUSBAR FIXING ASSEMBLY

(71) Applicant: Delta Electronics (Shanghai) Co., Ltd., Shanghai (CN)

(72) Inventors: Guanying WANG, Shanghai (CN); Peiai YOU, Shanghai (CN); Jian LI, Shanghai (CN)

(21) Appl. No.: 18/963,805

(22) Filed: Nov. 29, 2024

(30) Foreign Application Priority Data
Dec. 26, 2023 (CN) 202311814319.3

(51) Int. Cl. H02G 5/02

(52) U.S. Cl. CPC H02G 5/025

(57) ABSTRACT

The present application provides a busbar fixing assembly, including an auxiliary fixing member and a guide channel, where the auxiliary fixing member is detachably connected with a bracket holder; the guide channel includes a first segment arranged along a first direction and a second segment arranged along a second direction, and the guide channel is used for fixing the busbar, and two ends of the busbar extends outwards along the first direction and the second direction respectively; where the first segment is formed in the auxiliary fixing member or is formed by the auxiliary fixing member and the bracket holder; the second segment is formed by the auxiliary fixing member and the bracket holder; and the first direction and the second direction are two different directions in a same plane.

### CROSS-REFERENCE TO RELATED APPLICATION

The present application claims priority to Chinese Patent Application No. 202311814319.3, filed on Dec. 26, 2023. The aforementioned patent application is hereby incorporated by reference in its entirety.

### TECHNICAL FIELD

The present application relates to the manufacturing technology of electronic components, and in particular, to a busbar fixing assembly.

### BACKGROUND

Busbar is a commonly used electronic component, and is often used to realize the electrical connection between different devices.

In the solution of related technology, the busbar can be fixed by a bracket holder, and an installation groove is arranged in the bracket holder, one part of the busbar is arranged in the installation groove, and a through hole is further arranged on the bracket holder, and the other part of the busbar is exposed outside the bracket holder after passing through the through hole, so as to connect external devices.

In order to firmly fix the busbar in the bracket holder, it is necessary to use a fastener such as hook to clamp and fix the busbar to the bracket holder at a position near the through hole. However, the busbar may interfere with the hook during installation, resulting in the risk of hook fracture, which reduces the reliability of the fixing and even affects the normal use of the busbar in a serious case.

### SUMMARY

In order to overcome the above defects in the related technology, an object of the present application is to provide a busbar fixing assembly, and the present application can improve the reliability of fixing of a busbar and ensure the normal use of the busbar.

The present application provides a busbar fixing assembly, including:

an auxiliary fixing member detachably connected to a bracket holder;

a guide channel, including a first segment arranged along a first direction and a second segment arranged along a second direction, where the guide channel is used for fixing the busbar, and two ends of the busbar extend outwards along the first direction and the second direction, respectively;

where the first segment is formed in the auxiliary fixing member or is formed by the auxiliary fixing member and the bracket holder; the second segment is formed by the auxiliary fixing member and the bracket holder; and

the first direction and the second direction are two different directions in a same plane.

The present application forms a guide channel for fixing the busbar by connecting the auxiliary fixing member with the bracket holder; and the busbar is arranged in the guide channel and thus will not interfere with the auxiliary fixing member when it is fixed, which is beneficial to improve the reliability of fixing of the busbar and ensure a normal use of the busbar.

### BRIEF DESCRIPTION OF DRAWINGS

In order to more clearly illustrate the technical solution in the embodiments of the present application or in the related technology, the following will briefly introduce the accompanying drawings that need to be used in description of the embodiments or related technology, and obviously, the accompanying drawings described below are some of the embodiments of the present application, and for those skilled in the art, other accompanying drawings can be obtained according to these accompanying drawings without creative work.

FIG. 1 is a structural schematic diagram of a busbar fixing assembly provided by an embodiment of the present application.

FIG. 2 is a structural schematic diagram of a first part of an auxiliary fixing member provided by an embodiment of the present application.

FIG. 3 is a structural schematic diagram of a second part of an auxiliary fixing member provided by an embodiment of the present application.

FIG. 4 is a structural schematic diagram of a first part of an auxiliary fixing member provided by another embodiment of the present application.

FIG. 5 is a structural schematic diagram of a second part of an auxiliary fixing member provided by another embodiment of the present application.

FIG. 6 is a structural schematic diagram of an auxiliary fixing member provided by another embodiment of the present application from a first perspective.

FIG. 7 is a structural schematic diagram of an auxiliary fixing member provided by another embodiment of the present application from a second perspective.

FIG. 8 is a structural schematic diagram of a first part of an auxiliary fixing member provided by another embodiment of the present application.

FIG. 9 is a structural schematic diagram of a second part of an auxiliary fixing member provided by another embodiment of the present application.

FIG. 10 is a partial structural schematic diagram of a bracket holder provided by an embodiment of the present application.

### REFERENCE SIGNS

100—auxiliary fixing member

110—first part; 111—first side wall; 112—first top wall; 1121—first flange; 113—first convex rib; 1131—first bulge; 114—second convex rib; 1141—second bulge;

120—second part; 121—second side wall; 122—second top wall; 1221—second flange; 123—third convex rib; 1231—first groove; 124—fourth convex rib; 1241—second groove;

130—first connecting seat; 131—first connecting hole; 132—first bumper;

140—second connecting seat; 141—second connecting hole; 142—second bumper;

200—bracket holder; 201—first through hole; 202—second through hole; 203—third through hole; 204—first fixing seat; 2041—first fixing hole; 2042—first matching groove; 205—second fixing seat; 2051—second fixing hole; 2052—second matching groove;

210—guide part;

221—first installation groove; 222—second installation groove; 223—third installation groove;

300—guide channel; 301—first segment; 302—second segment; 303—transition segment;

310—first guide channel; 311—first segment of the first guide channel; 312—second segment of the first guide channel; 313—transition segment of the first guide channel;

320—second guide channel; 321—first segment of the second guide channel; 322—second segment of the second guide channel; 323—transition segment of the second guide channel;

330—third guide channel; 331—first segment of the third guide channel; 332—second segment of the third guide channel; 333—transition segment of the third guide channel;

400—busbar; 410—first busbar; 420—second busbar; 430—third busbar;

X—first direction; Y—second direction; Z—third direction.

### DESCRIPTION OF EMBODIMENTS

In order to make the purposes, technical solutions and advantages of the embodiments of the present application more clear, the technical solutions in the embodiments of the present application will be described clearly and completely in combination with the accompanying drawings of the embodiments of the present application. Obviously, the embodiments described are some of embodiments of the present application, but not all embodiments.

Based on the embodiments in the present application, all other embodiments obtained by those skilled in the art without creative work fall within the protection scope of the present application. The following embodiments and the features in the embodiments may be combined with each other in the absence of conflict.

As described in the background, in order to firmly secure a busbar in a bracket holder, a fastener such as hook can be arranged on the bracket holder at a position near the through hole to assist in fixing the busbar. Taking the hook as an example, when the busbar is installed, it is necessary to open both sides of the hook first to make the busbar pass through, and then the hook returns under the action of its own elastic force, so as to lock the busbar between the hook and the bracket holder. In the above process, the hook may be broken when opening the hook, which reduces the reliability of fixing, and even affects a normal use of the busbar.

In view of this, an object of the an embodiment of the present application is to provide a busbar fixing assembly, including an auxiliary fixing member which is detachably connected to a bracket holder. The auxiliary fixing member and the bracket holder jointly form a guide channel for fixing the busbar, and the busbar is arranged in the guide channel, and the busbar will not interfere with the auxiliary fixing member when being fixed, thereby improving the reliability of fixing of the busbar and ensuring the normal use of the busbar.

The embodiments of the present application will be described in detail in combination with the accompanying drawings below, so that those skilled in the art can have a more detailed understanding of the contents of the present application.

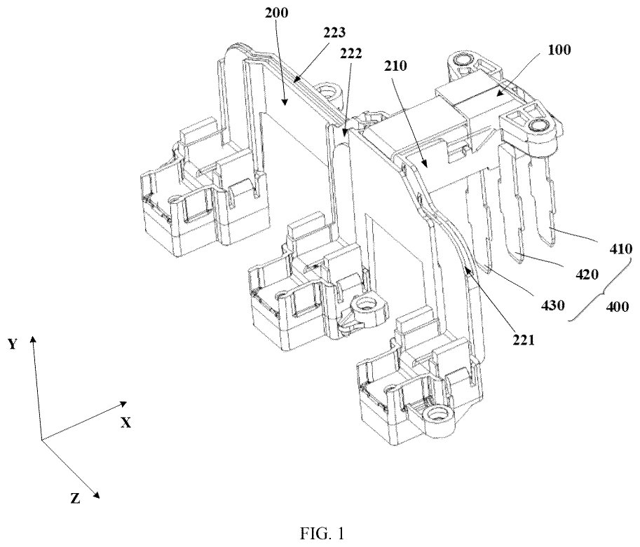

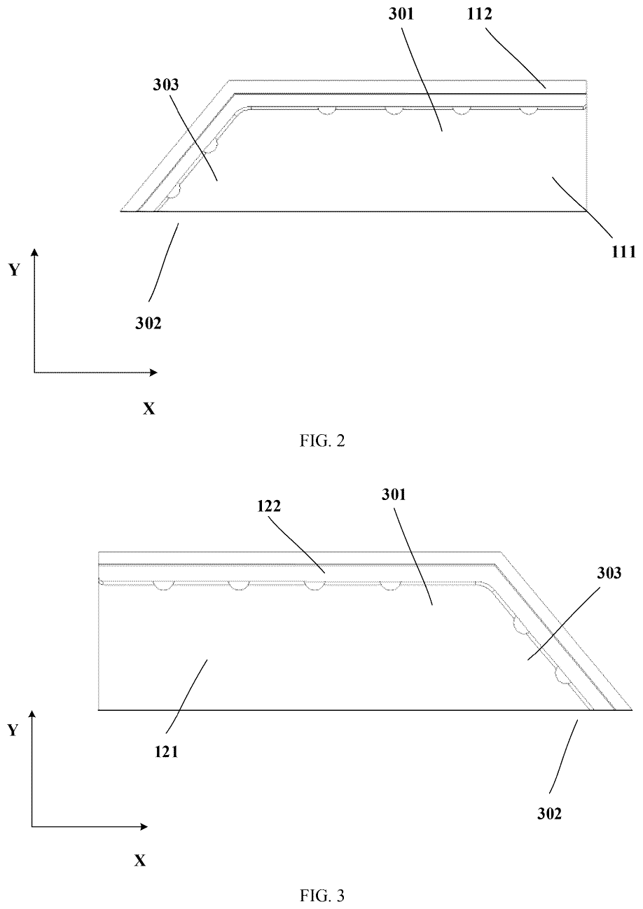

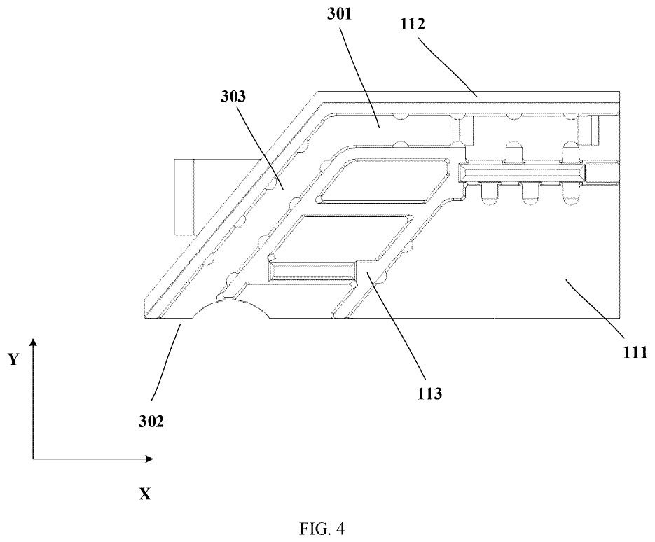

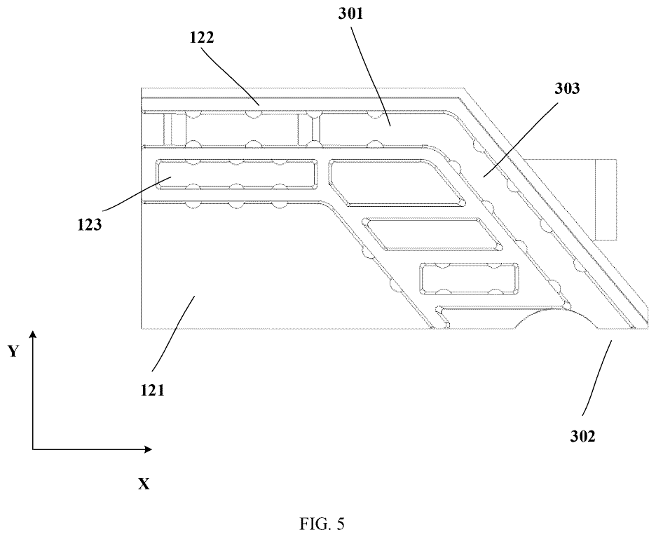

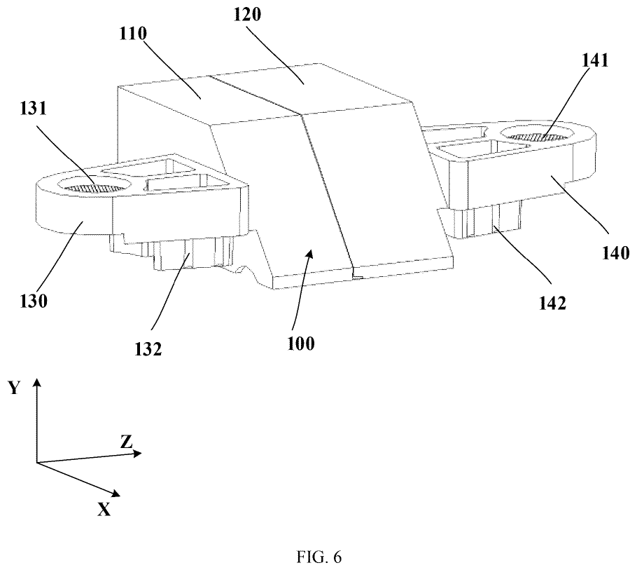

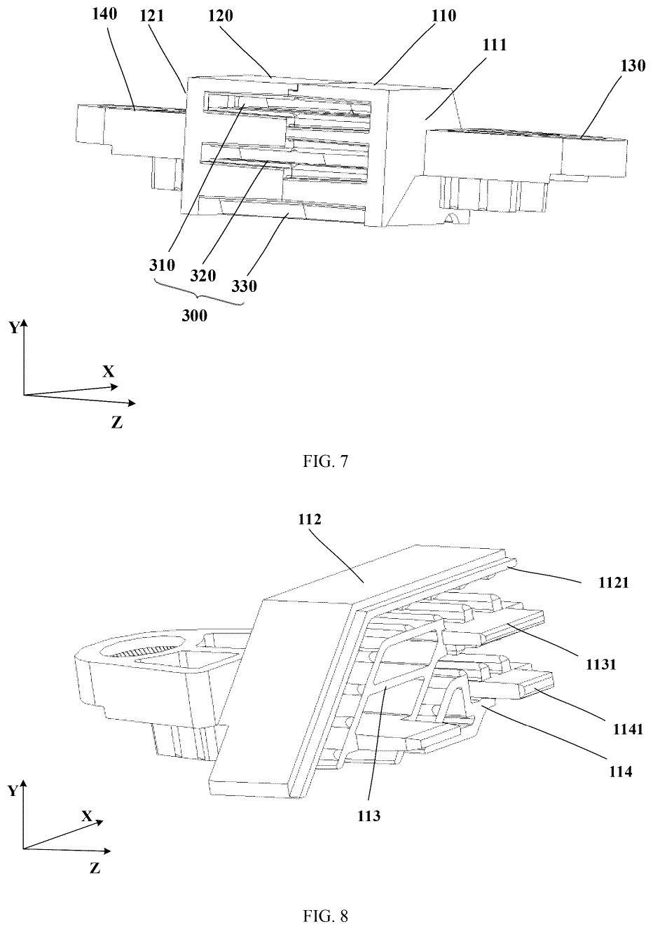

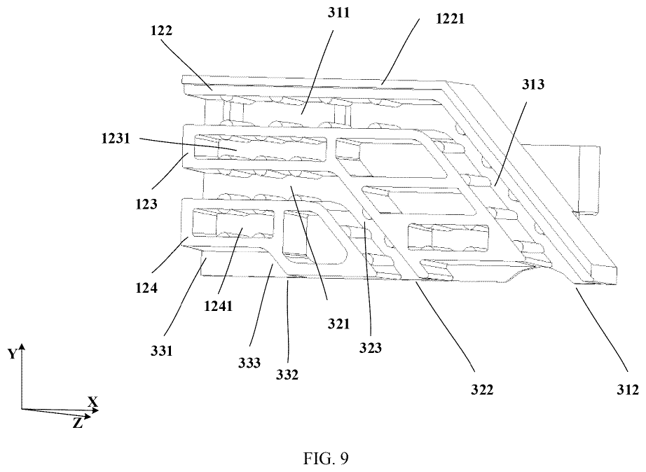

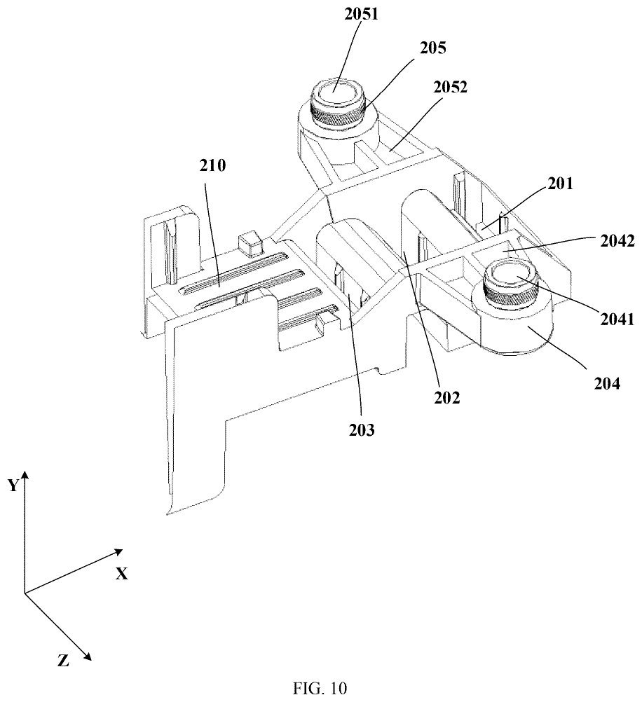

FIG. 1 is a structural schematic diagram of a busbar fixing assembly provided by an embodiment of the present application; FIG. 2 is a structural schematic diagram of a first part of an auxiliary fixing member provided by an embodiment of the present application; FIG. 3 is a structural schematic diagram of a second part of an auxiliary fixing member provided by an embodiment of the present application; FIG. 4 is a structural schematic diagram of a first part of an auxiliary fixing member provided by another embodiment of the present application; FIG. 5 is a structural schematic diagram of a second part of an auxiliary fixing member provided by another embodiment of the present application; FIG. 6 is a structural schematic diagram of an auxiliary fixing member provided by another embodiment of the present application from a first perspective; FIG. 7 is a structural schematic diagram of an auxiliary fixing member provided by another embodiment of the present application from a second perspective; FIG. 8 is a structural schematic diagram of a first part of an auxiliary fixing member provided by another embodiment of the present application; FIG. 9 is a structural schematic diagram of a second part of an auxiliary fixing member provided by another embodiment of the present application; FIG. 10 is a partial structural schematic diagram of a bracket holder provided by an embodiment of the present application.

Referring to FIG. 1-FIG. 10, the present embodiment provides a busbar fixing assembly including:

an auxiliary fixing member 100 detachably connected to a bracket holder 200, where the auxiliary fixing member 100 can be detachably connected to the bracket holder 200 by a structure such as screw, bolt or hook; and

a guide channel 300 including a first segment 301 arranged along a first direction X and a second segment 302 arranged along a second direction Y, where the first direction X and the second direction Y are two different directions in a same plane. The guide channel 300 is used for fixing a busbar 400, and two ends of the busbar 400 extend outwards along the first direction X and the second direction Y, respectively. The first segment 301 is formed in the auxiliary fixing member 100, or is formed by the auxiliary fixing member 100 and the bracket holder 200. The second segment 302 is formed by the auxiliary fixing member 100 and the bracket holder 200. The auxiliary fixing member 100 and the bracket holder 200 together limit the busbar 400 within the guide channel 300, and the busbar 400 is arranged inside the guide channel 300 and does not interfere with the auxiliary fixing member 100 during fixing, thereby preventing the busbar 400 from falling out from the bracket holder 200 and improving the reliability of fixing the busbar 400.

In one possible implementation, a thickness direction of the busbar 400 of the present embodiment is always parallel to the plane formed by the first direction X and the second direction Y; that is, the busbar 400 of the present embodiment is bent in the plane formed by the first direction X and the second direction Y.

Furthermore, the first direction X in the present embodiment is perpendicular to the second direction Y, and after the busbar 400 passes through the guide channel 300, an extension direction of the busbar 400 is changed by 90°. It should be noted that in other possible implementations, the first direction X and the second direction Y may not be perpendicular to each other, and there may be an acute or obtuse angle between the extension direction of the busbar 400 after passing through the guide channel 300 and its original extension direction, which can be set according to an actual installation need.

Please continue to refer to FIG. 2-FIG. 9, in order to facilitate the installation and removal of the auxiliary fixing member 100, the auxiliary fixing member 100 of the present embodiment includes a first part 110 and a second part 120 arranged in a third direction Z, and both the first part 110 and the second part 120 are detachably connected, the first part 110 and the second part 120 can be inserted opposite each other from two sides of the busbar 400 in use to limit the busbar 400 to be within the guide channel 300, and during the installation process, the busbar 400 will not interfere with the first part 110 and the second part 120.

In one possible implementation, as shown in FIGS. 2 and 3, the first part 110 of the present embodiment includes a first top wall 112 extending in the third direction Z, and a first side wall 111, and; and the second part 120 includes a second top wall 122 extending in the third direction Z, and a second side wall 121.

When the first part 110 is matched with the second part 120, the first top wall 112 and the second top wall 122 are interconnected, and the first top wall 112, the second top wall 122 and the bracket holder 200 are combined to form the first segment 301.

In an embodiment, the bracket holder 200 of the present embodiment is provided with a through hole, and the through hole is combined with the auxiliary fixing member 100 to form the second segment 302, thereby limiting the busbar 400 between the through hole and the auxiliary fixing member 100.

Further, the guide channel 300 further includes a transition segment 303 for connecting the first segment 301 with the second segment 302. The setting of the transition segment 303 makes the first part 110 and the second part 120 more easily filled to be saturated during molding, which is conducive to increasing the yield rate of good products; in addition, the setting of the transition segment 303 is conducive to improving the overall strength of the guide channel 300. The busbar 400 includes a busbar transition segment for connecting two ends of the busbar 400, and the transition segment 303 is configured to define the busbar transition segment. After setting the busbar transition segment, the risk of cracking of the busbar 400 can be reduced, thereby ensuring good electrical performance. By designing the transition segment, the present embodiment can improve the structural stability of the busbar 400 and at the same time improve the fixing effect of the guide channel 300 on the busbar 400. After actual installation, the busbar 400 will be subjected to a bearing force along the second direction. By designing the transition segment 303, it can also reduce the deformation of the busbar 400 after being subjected to the bearing force along the second direction, and also reduce the vibration under actual working conditions, it is helpful to improve the reliability of the overall operation of the device.

In an embodiment, the transition segment 303 may be formed by the first top wall 112, the second top wall 122 and the bracket holder 200.

In another possible implementation, as shown in FIGS. 4 and 5, the first part 110 of the present embodiment includes a first top wall 112, a first convex rib 113 and a first side wall 111, where the first top wall 112 and the first convex rib 113 both extend in the third direction Z. The second part 120 includes a second top wall 122, a third convex rib 123 and a second side wall 121, where the second top wall 122 and the third convex rib 123 both extend in the third direction Z.

When the first part 110 is matched with the second part 120, the first top wall 112 is interconnected with the second top wall 122, and the first convex rib 113 is interconnected with the third convex rib 123; the first top wall 112, the second top wall 122, the first convex rib 113 and the third convex rib 123 are combined to form the first segment 301, that is, the first segment 301 is formed in the auxiliary fixing member without participation of the bracket holder 200.

In an embodiment, the bracket holder 200 of the present embodiment is provided with a through hole, and the through hole is combined with the auxiliary fixing member 100 to form the second segment 302, thereby limiting the busbar 400 between the through hole and the auxiliary fixing member 100.

Further, the guide channel 300 further includes a transition segment 303 for connecting the first segment 301 with the second segment 302. The busbar 400 includes a busbar transition segment for connecting two ends of the busbar 400, and the transition segment 303 is used to define the busbar transition segment, that is, the transition segment 303 is formed in the auxiliary fixing member without participation of the bracket holder.

In an embodiment, the transition segment 303 may be formed by the first top wall 112, the second top wall 122, the first convex rib 113 and the third convex rib 123.

Please continue to refer to FIGS. 1 and 6-10, in one possible implementation, the guide channel 300 of the present embodiment includes a first guide channel 310, a second guide channel 320 and a third guide channel 330 arranged at intervals, and the busbar 400 includes a first busbar 410, a second busbar 420 and a third busbar 430, where the first guide channel 310 is used for fixing the first busbar 410, the second guide channel 320 is used for fixing the second busbar 420, and the third guide channel 330 is used for fixing the third busbar 430. The first guide channel 310, the second guide channel 320 and the third guide channel 330 may be set at intervals in the second direction Y or in the third direction Z.

The bracket holder 200 is provided with a guide part 210 extending along the first direction X, and the first busbar 410, the second busbar 420 and the third busbar 430 are all arranged in the guide part 210 along the first direction X.

Specifically, the first busbar 410 is arranged in the first guide channel 310, the second busbar 420 is arranged in the second guide channel 320, and the third busbar 430 is arranged in the third guide channel 330.

An end of the guide part 210 is provided with a through hole, an axis of the through hole is parallel to the second direction Y, and the first busbar 410, the second busbar 420 and the third busbar 430 all extend outwards along the second direction Y after passing through the through hole.

In the above structure, the present embodiment uses the first guide channel 310, the second guide channel 320 and the third guide channel 330, which are formed by the auxiliary fixing member 100 and the bracket holder 200 together, to firmly limit the first busbar 410, the second busbar 420 and the third busbar 430 between the auxiliary fixing member 100 and the bracket holder 200, thereby preventing the first busbar 410, the second busbar 420 and the third busbar 430 from falling off. And as the fixing mode of the busbars in the auxiliary fixing member is fully surrounded, the problem of short circuit due to contact between different busbars can be effectively prevented.

Specifically, the first busbar 410 of the present embodiment includes a first segment of the first busbar extending in the first direction X and a second segment of the first busbar extending in the second direction Y. Accordingly, the first guide channel 310 includes a first segment 311 of the first guide channel arranged along the first direction X and a second segment 312 of the first guide channel arranged along the second direction Y, the first segment 311 of the first guide channel is formed in the auxiliary fixing member 100 and is used for fixing the first segment of the first busbar, and the second segment 312 of the first guide channel is formed by the auxiliary fixing member 100 and the bracket holder 200 and is used for fixing the second segment of the first busbar.

In an embodiment, the bracket holder 200 is provided with a first through hole 201, and the second segment of the first guide channel 312 is formed by the auxiliary fixing member 100 and the first through hole 201.

The second busbar 420 includes a first segment of the second busbar extending in the first direction X and a second segment of the second busbar extending in the second direction Y. Accordingly, the second guide channel 320 includes a first segment 321 of the second guide channel arranged along the first direction X and a second segment 322 of the second guide channel arranged along the second direction Y, and the first segment 321 of the second guide channel is formed in the auxiliary fixing member 100 and is used for fixing the first segment of the second busbar, and the second segment 322 of the second guide channelis formed by the auxiliary fixing member 100 and the bracket holder 200 and is used for fixing the second segment of the second busbar.

In an embodiment, the bracket holder 200 is provided with a second through hole 202, and the second segment 322 of the second guide channel is formed by the auxiliary fixing member 100 and the second through hole 202.

The third busbar 430 includes a first segment of the third busbar extending in the first direction X and a second segment of the third busbar extending in the second direction Y. Accordingly, the third guide channel 330 includes a first segment 331 of the third guide channel arranged along the first direction X and a second segment 332 of the third guide channel arranged along the second direction Y, the first segment 331 of the third guide channel is formed by the auxiliary fixing member 100 and the bracket holder 200 and is used for fixing the first segment of the third busbar, and the second segment 332 of the third guide channel is formed by the auxiliary fixing member 100 and the bracket holder 200 and is used for fixing the second segment of the third busbar.

In an embodiment, the bracket holder 200 is further provided with a third through hole 203, and the second segment 332 of the third guide channel is formed by the auxiliary fixing member 100 and the third through hole 203.

Further, the first busbar 410 of the present embodiment further includes a transition segment of the first busbar for connecting the first segment of the first busbar with the second segment of the first busbar. Accordingly, the first guide channel 310 further includes a transition segment 313 of the first guide channel for connecting first segment 311 of the first guide channel with the second segment 312 of the first guide channel, and the transition segment 313 of the first guide channel is formed in the auxiliary fixing member 100, and the transition segment 313 of the first guide channel is used for fixing the transition segment of the first busbar.

Specifically, the transition segment 313 of the first guide channel may be formed by the first part 110 and the second part 120.

The second busbar 420 further includes a transition segment of the second busbar for connecting the first segment of the second busbar with the second segment of the second busbar. Accordingly, the second guide channel 320 further includes a transition segment 323 of the second guide channel for connecting the first segment 321 of the second guide channel with the second segment 322 of the second guide channel, and the transition segment 323 of the second guide channel is formed in the auxiliary fixing member 100, and the transition segment 323 of the second guide channel is used for fixing the transition segment of the second busbar.

Specifically, the transition segment 323 of the second guide channel is formed by the first part 110 and the second part 120.

The third busbar 430 further includes a transition segment of the third busbar for connecting the first segment of the third busbar with the second segment of the third busbar. Accordingly, the third guide channel 330 further includes a transition segment 333 of the third guide channel for connecting the first segment 331 of the third guide channel with the second segment 332 of the third guide channel, and the transition segment 333 of the third guide channel is formed by the auxiliary fixing member 100 and the bracket holder 200, and the transition segment 333 of the third guide channel is used for fixing the transition segment of the third busbar.

Specifically, the transition segment 333 of the third guide channel is formed by the first part 110, the second part 120 and the bracket holder 200.

Please continue to refer to FIGS. 6-9. In the present embodiment, the first part 110 includes a first top wall 112, a first convex rib 113, a second convex rib 114 and a first side wall 111, wherein the first top wall 112, the first convex rib 113 and the second convex rib 114 all extend in the third direction Z. The second part 120 includes a second top wall 122, a third convex rib 123, a fourth convex rib 124 and a second side wall 121, wherein the second top wall 122, the third convex rib 123, the fourth convex rib 124 all extend in the third direction Z.

When the first part 110 is matched with the second part 120, the first top wall 112 is interconnected with the second top wall 122, the first convex rib 113 is interconnected with the third convex rib 123, and the second convex rib 114 is interconnected with the fourth convex rib 124. The first top wall 112, the second top wall 122, the first convex rib 113 and the third convex rib 123 are combined to form the first segment 311 of the first guide channel. The first convex rib 113, the third convex rib 123, the second convex rib 114 and the fourth convex rib 124 are combined to form the first segment 321 of the second guide channel. The second convex rib 114, the fourth convex rib 124 and the bracket holder 200 are combined to form the first segment 331 of the third guide channel.

Further, in the present embodiment, along the third direction Z, the first top wall 112 is provided with a first flange 1121, the first convex rib is provided with at least one first bulge 1131, and the second convex rib 114 is provided with at least one second bulge 1141.

Along the third direction Z, the second top wall 122 is provided with a second flange 1221, the third convex rib 123 is provided with at least one first groove 1231, and the fourth convex rib 124 is provided with at least one second groove 1241.

When the first part 110 is matched with the second part 120, the first flange 1121 is lapped with the second flange 1221, the first bulge 1131 is inserted into the first groove 1231 in the third direction Z, and the second bulge 1141 is inserted into the second groove 1241 in the third direction Z, the detachable connection between the first part 110 and the second part 120 is realized through the above mortise and tenon structure.

Further, the first top wall 112 includes a first segment of the first top wall arranged in the first direction X and a second segment of the first top wall inclined to the first segment of the first top wall, the first convex rib 113 includes a first segment of the first convex rib arranged along the first direction X and a second segment of the first convex rib inclined to the first segment of the first convex rib, and the second convex rib 114 includes a first segment of the second convex rib arranged along the first direction X and a second segment of the second convex rib inclined to the first segment of the second convex rib.

The second top wall 122 includes a first segment of the second top wall arranged along the first direction X and a second segment of the second top wall inclined to the first segment of the second top wall. The third convex rib 123 includes a first segment of the third convex rib arranged along the first direction X and a second segment of the third convex rib inclined to the first segment of the third convex rib. The fourth convex rib 124 includes a first segment of the fourth convex rib arranged along the first direction X and a second segment of the fourth convex rib inclined to the first segment of the fourth convex rib.

The above first segment 311 of the first guide channel can be formed by the first segment of the first top wall, the first segment of the second top wall, the first segment of the first convex rib and the first segment of the third convex rib. The above transition segment 313 of the first guide channel may be formed by the second segment of the first top wall, the second segment of the second top wall, the second segment of the first convex rib and the second segment of the third convex rib.

The above first segment 321 of the second guide channel may be formed by the first segment of the first convex rib, the first segment of the third convex rib, the first segment of the second convex rib and the first segment of the fourth convex rib. The above transition segment 323 of the second guide channel may be formed by the second segment of the first convex rib, the second segment of the third convex rib, the second segment of the second convex rib and the second segment of the fourth convex rib.

The above first segment 331 of the third guide channel may be formed by the first segment of the second convex rib, the first segment of the fourth convex rib and the bracket holder 200. The above transition segment 333 of the third guide channel may be formed by the second segment of the second convex rib, the second segment of the fourth convex rib and the bracket holder 200.

In the present embodiment, the first guide channel 310, the second guide channel 320 and the third guide channel 330 are arranged at intervals in the second direction Y.

In other possible implementation, the first guide channel 310, the second guide channel 320 and the third guide channel 330 may also be arranged at intervals in the third direction Z, where the first direction X, the second direction Y and the third direction Z are perpendicular to each other. In the present implementation, the first busbar 410 leading out of a first installation groove 221, the second busbar 420 leading out of a second installation groove 222 and the third busbar 430 leading out of a third installation groove 223 are arranged in the guide part 210 at interval in the third direction Z, the first guide channel 310, the second guide channel 320 and the third guide channel 330 may all be formed in the auxiliary fixing member 100, or are all formed by the auxiliary fixing member 100 and the bracket holder 200.

In one possible implementation, in the present embodiment, a side of the first top wall 112 facing the first convex rib 113, a side of the first convex rib 113 facing the first top wall 112, a side of the first convex rib 113 facing the second convex rib 114, a side of the second convex rib 114 facing the first convex rib 113, a side of the second top wall 122 facing the third convex rib 123, a side of the third convex rib 123 facing the second top wall 122, a side of the third convex rib 123 facing the fourth convex rib 124, a side of the fourth convex rib 124 facing the third convex rib 123 are all provided with a reinforcing rib. When the busbar is fixed inside the auxiliary fixing member 100, the reinforcing rib abuts against the first busbar 410, the second busbar 420 and the third busbar 430, thereby making the fixing more secure. At the same time, the first groove 1231 and the second groove 1241 may also be internally provided with a reinforcing rib, which is used to make the first bulge 1131 and the second bulge 1141 more tight after being inserted into corresponding the first groove 1231 and the second groove 1241 respectively when the first part 110 is connected with the second part 120. The reinforcing rib has a certain elasticity, and thus even if there is a certain error in other parts of the auxiliary fixing member 100, such as in the first top wall 112 or the first convex rib 113, the busbar 400 can be well abutted and fixed in the auxiliary fixing member by the elasticity of the reinforcing rib. In addition, in the process of practical use, the reinforcing rib can also filter the vibration of the system and ensure the reliability of the fixation of the busbar.

Please continue to refer to FIGS. 1, 6, 7 and 10, along the third direction Z, the auxiliary fixing member 100 of the present embodiment further includes a first connecting seat 130 and a second connecting seat 140, where the first connecting seat 130 is arranged on a side of the first part 110 away from the second part 120, the second connecting seat 140 is arranged on a side of the second part 120 away from the first part 110, the first connecting seat 130 is provided with a first connecting hole 131, and the second connecting seat 140 is provided with a second connecting hole 141.

The two sides of the bracket holder 200 are respectively provided with a first fixing seat 204 and a second fixing seat 205 along the third direction Z, the first fixing seat 204 is provided with a first fixing hole 2041, and the second fixing seat 205 is provided with a second fixing hole 2051.

The first fixing hole 2041 is detachably connected with the first connecting hole 131, and the second fixing hole 2051 is detachably connected with the second connecting hole 141, thereby realizing the connection and fixation between the auxiliary fixing member 100 and the bracket holder 200. In an embodiment, by causing a screw to pass through the first connecting hole 131 and the first fixing hole 2041 and then be locked to a housing of an electronic device, and causing a screw to pass through the second connecting hole 141 and the second fixing hole 2051 and then be locked to the housing of the electronic device, it is possible to fix the auxiliary fixing member 100 with the bracket holder 200, and meanwhile to fix the third busbar 430 between the auxiliary fixing member 100 and the bracket holder 200.

Further, the first connecting seat 130 of the present embodiment is provided with a plurality of first bumpers 132, the first fixing seat 204 is provided with a plurality of first matching grooves 2042, and each of the plurality of first bumpers 132 correspond to one of the plurality of first matching grooves 2042, and the first bumpers 132 are inserted into corresponding first matching grooves 2042.

The second connecting seat 140 is also provided with a plurality of second bumpers 142, the second fixing seat 205 is provided with a plurality of second matching grooves 2052. Each of the plurality of second bumpers 142 correspond to one of the plurality of second matching grooves 2052, and the second bumpers 142 are inserted into corresponding second matching grooves 2052.

Through the above structure of the first bumpers 132 and the first matching grooves 2042, and the above structure of the second bumpers 142 and the second matching grooves 2052 in the present embodiment, it not only improves the connection stability between the auxiliary fixing member 100 and the bracket holder 200, but also plays a role in installation guidance, which is beneficial to improve the installation efficiency of the auxiliary fixing member 100.

In the description of the present application, it should be understood that, the terms “center”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, etc.,, which indicate orientation or position relationships based on the orientation or position relationships shown in the accompanying drawings, are only for the purpose of facilitating and simplifying the description of the present application, and do not indicate or imply that the device or element referred to must have a specific orientation, or construction and operation in a specific orientation and therefore shall not be construed as a limitation of the present application.

In the present application, unless otherwise clearly specified and defined, the terms “installation”, “linked”, “connection” and “fixed” shall be understood in a broad sense, for example, they can refer to a fixed connection, a detachable connection, or an integral connection; they can refer to a direct connection, an indirect connection through an intermediary, or they can be an internal communication between two elements or an interaction between two elements. For those skilled in the art, the specific meanings of the above terms in the present application can be understood according to the specific circumstances.

It should be noted that in the description of the present application, the terms “first” and “second” are only used to facilitate the description of different components, and they cannot be understood to indicate or imply sequential relations, relative importance or implicitly indicate the number of indicated technical features. Thus, a feature defined by “first” and “second” may include at least one such feature either expressly or implicitly.

In the present application, the embodiments or implementations of the present application are described in a progressive manner, and each embodiment focuses on the differences from other embodiments, and the same or similar parts of various embodiments can refer to each other.

In the present application, the description with reference to terms “one implementation”, “some implementations”, “schematic implementations”, “examples”, “specific examples”, or “some examples” mean that the specific features, structures, materials or features described in combination with implementations or examples are included in at least one implementation or example of the present application. In the present application, the schematic representation of the above terms does not necessarily refer to the same implementation or example. Furthermore, the specific features, structures, materials or features described may be combined in an appropriate manner in any one or more implementations or examples.

Finally, it should be noted that the above embodiments are only used to illustrate the technical solutions of the present application, and not to restrict it; although the present application has been described in detail with reference to the foregoing embodiments, it should be understood by those skilled in the art that they may modify the technical solutions described in the foregoing embodiments, or make equivalent substitutions for some or all of the technical features therein; these modifications or substitutions shall not make the essence of the corresponding technical solutions depart from the scope of the technical solutions of the embodiments of the present application.

What is claimed is:

1. A busbar fixing assembly, comprising:
an auxiliary fixing member, detachably connected to a bracket holder; and
a guide channel, comprising a first segment arranged along a first direction and a second segment arranged along a second direction, wherein the guide channel is used for fixing a busbar, and two ends of the busbar extend outwards along the first direction and the second direction, respectively;
wherein the first segment is formed in the auxiliary fixing member, or the first segment is formed by the auxiliary fixing member and the bracket holder; and the second segment is formed by the auxiliary fixing member and the bracket holder; and
the first direction and the second direction are two different directions in a same plane.

2. The busbar fixing assembly according to claim 1, wherein a thickness direction of the busbar is parallel to a plane formed by the first direction and the second direction.

3. The busbar fixing assembly according to claim 2, wherein the first direction is perpendicular to the second direction.

4. The busbar fixing assembly according to claim 3, wherein the guide channel further comprises a transition segment for connecting the first segment with the second segment.

5. The busbar fixing assembly according to claim 3, wherein the guide channel comprises a first guide channel, a second guide channel and a third guide channel arranged at intervals, the busbar comprises a first busbar, a second busbar and a third busbar, the first guide channel is used for fixing the first busbar, the second guide channel is used for fixing the second busbar, and the third guide channel is used for fixing the third busbar.

6. The busbar fixing assembly according to claim 5, wherein
the first guide channel comprises a first segment of the first guide channel arranged along the first direction and a second segment of the first guide channel arranged along the second direction, the first segment of the first guide channel is formed in the auxiliary fixing member, the second segment of the first guide channel is formed by the auxiliary fixing member and the bracket holder;
the second guide channel comprises a first segment of the second guide channel arranged along the first direction and a second segment of the second guide channel arranged along the second direction, the first segment of the second guide channel is formed in the auxiliary fixing member, the second segment of the second guide channel is formed by the auxiliary fixing member and the bracket holder; and
the third guide channel comprises a first segment of the third guide channel arranged along the first direction and a second segment of the third guide channel arranged along the second direction, and the first segment of the third guide channel is formed by the auxiliary fixing member and the bracket holder, the second segment of the third guide channel is formed by the auxiliary fixing member and the bracket holder.

7. The busbar fixing assembly according to claim 6, wherein
the first guide channel further comprises a transition segment of the first guide channel for connecting the first segment of the first guide channel with the second segment of the first guide channel, and the transition segment of the first guide channel is formed in the auxiliary fixing member;
the second guide channel further comprises a transition segment of the second guide channel for connecting the first segment of the second guide channel with the second segment of the second guide channel, and the transition segment of the second guide channel is formed in the auxiliary fixing member; and
the third guide channel further comprises a transition segment of the third guide channel for connecting the first segment of the third guide channel with the second segment of the third guide channel, and the transition segment of the third guide channel is formed by the auxiliary fixing member and the bracket holder.

8. The busbar fixing assembly according to claim 5, wherein the first guide channel, the second guide channel and the third guide channel are arranged at intervals along the second direction.

9. The busbar fixing assembly according to claim 5, wherein the first guide channel, the second guide channel and the third guide channel are arranged at intervals along a third direction;
wherein the first direction, the second direction and the third direction are perpendicular to each other.

10. The busbar fixing assembly according to claim 1, wherein the bracket holder is provided with a through hole, and the through hole is combined with the auxiliary fixing member to form the second segment.

11. The busbar fixing assembly according to claim 1, wherein the auxiliary fixing member comprises a first part and a second part disposed in a third direction, and the first part and the second part are detachably connected;
wherein the third direction is perpendicular to a plane where the first direction and the second direction are located.

12. The busbar fixing assembly according to claim 11, wherein
the first part comprises a first top wall extending in the third direction and a first side wall;
the second part comprises a second top wall extending in the third direction and a second side wall;
the first top wall is interconnected with the second top wall; and
the first top wall, the second top wall and the bracket holder are combined to form the first segment.

13. The busbar fixing assembly according to claim 12, wherein
the guide channel further comprises a transition segment for connecting the first segment with the second segment;
the first top wall, the second top wall and the bracket holder are combined to form the transition segment.

14. The busbar fixing assembly according to claim 11, wherein
the first part comprises a first top wall, a first convex rib and a first side wall, wherein both of the first top wall and the first convex rib extend in the third direction;
the second part comprises a second top wall, a third convex rib and a second side wall, wherein both of the second top wall and the third convex rib extend in the third direction;
the first top wall is interconnected with the second top wall, and the first convex rib is interconnected with the third convex rib; and
the first top wall, the second top wall, the first convex rib and the third convex rib are combined to form the first segment.

15. The busbar fixing assembly according to claim 14, wherein
the guide channel further comprises a transition segment for connecting the first segment with the second segment; and
the first top wall, the second top wall, the first convex rib and the third convex rib are combined to form the transition segment.

16. The busbar fixing assembly according to claim 11, wherein the guide channel comprises a first guide channel, a second guide channel and a third guide channel arranged at intervals, the busbar comprises a first busbar, a second busbar and a third busbar, the first guide channel is used for fixing the first busbar, the second guide channel is used for fixing the second busbar, and the third guide channel is used for fixing the third busbar.

17. The busbar fixing assembly according to claim 16, wherein the bracket holder is provided with a first through hole, a second through hole and a third through hole;
the first guide channel comprises a first segment of the first guide channel arranged along the first direction and a second segment of the first guide channel arranged along the second direction, the first segment of the first guide channel is formed by the first part and the second part, and the second segment of the first guide channel is formed by the auxiliary fixing member and the first through hole;
the second guide channel comprises a first segment of the second guide channel arranged along the first direction and a second segment of the second guide channel arranged along the second direction, the first segment of the second guide channel is formed by the first part and the second part, and the second segment of the second guide channel is formed by the auxiliary fixing member and the second through hole; and
the third guide channel comprises a first segment of the third guide channel arranged along the first direction and a second segment of the third guide channel arranged along the second direction, the first segment of the third guide channel is formed by the first part, the second part and the bracket holder, and the second segment of the third guide channel is formed by the auxiliary fixing member and the third through hole.

18. The busbar fixing assembly according to claim 17, wherein
the first guide channel further comprises a transition segment of the first guide channel for connecting the first segment of the first guide channel with the second segment of the first guide channel, and the transition segment of the first guide channel is formed by the first part and the second part;
the second guide channel further comprises a transition segment of the second guide channel for connecting the first segment of the second guide channel with the second segment of the second guide channel, and the transition segment of the second guide channel is formed by the first part and the second part; and
the third guide channel further comprises a transition segment of the third guide channel for connecting the first segment of the third guide channel with the second segment of the third guide channel, the transition segment of the third guide channel is formed by the first part, the second part and the bracket holder.

19. The busbar fixing assembly according to claim 17, wherein the first part comprises a first top wall, a first convex rib and a second convex rib, extending in the third direction, and a first side wall;
the second part comprises a second top wall, a third convex rib and a fourth convex rib, extending in the third direction, and a second side wall;
the first top wall is interconnected with the second top wall, the first convex rib is interconnected with the third convex rib, and the second convex rib is interconnected with the fourth convex rib; and
the first top wall, the second top wall, the first convex rib and the third convex rib are combined to form the first segment of the first guide channel; the first convex rib, the third convex rib, the second convex rib and the fourth convex rib are combined to form the first segment of the second guide channel; the second convex rib, the fourth convex rib and the bracket holder are combined to form the first segment of the third guide channel.

20. The busbar fixing assembly according to claim 19, wherein along the third direction, the first top wall is provided with a first flange, the first convex rib is provided with at least one first bulge, and the second convex rib is provided with at least one second bulge;
along the third direction, the second top wall is provided with a second flange, the third convex rib is provided with at least one first groove, and the fourth convex rib is provided with at least one second groove; and
the first flange is lapped with the second flange, the first bulge is inserted into the first groove in the third direction, and the second bulge is inserted into the second groove in the third direction.

21. The busbar fixing assembly according to claim 19, wherein
the first guide channel further comprises a transition segment of the first guide channel for connecting the first segment of the first guide channel with the second segment of the first guide channel; the second guide channel further comprises a transition segment of the second guide channel for connecting the first segment of the second guide channel with the second segment of the second guide channel; the third guide channel further comprises a transition segment of the third guide channel for connecting the first segment of the third guide channel with the second segment of the third guide channel;
the first top wall comprises a first segment of the first top wall arranged along the first direction and a second segment of the first top wall inclined to the first segment of the first top wall; the first convex rib comprises a first segment of the first convex rib arranged along the first direction and a second segment of the first convex rib inclined to the first segment of the first convex rib; the second convex rib comprises a first segment of the second convex rib arranged along the first direction and a second segment of the second convex rib inclined to the first segment of the second convex rib;
the second top wall comprises a first segment of the second top wall arranged along the first direction and a second segment of the second top wall inclined to the first segment of the second top wall, the third convex rib comprises a first segment of the third convex rib arranged along the first direction and a second segment of the third convex rib inclined to the first segment of the third convex rib, the fourth convex rib comprises a first segment of the fourth convex rib arranged along the first direction and a second segment of the fourth convex rib inclined to the first segment of the fourth convex rib;
the first segment of the first top wall, the first segment of the second top wall, the first segment of the first convex rib and the first segment of the third convex rib are combined to form the first segment of the first guide channel; the second segment of the first top wall, the second segment of the second top wall, the second segment of the first convex rib and the second segment of the third convex rib are combined to form the transition segment of the first guide channel;
the first segment of the first convex rib, the first segment of the third convex rib, the first segment of the second convex rib and the first segment of the fourth convex rib are combined to form the first segment of the second guide channel; the second segment of the first convex rib, the second segment of the third convex rib, the second segment of the second convex rib and the second segment of the fourth convex rib are combined to form the transition segment of the second guide channel;
the first segment of the second convex rib, the first segment of the fourth convex rib and the bracket holder are combined to form the first segment of the third guide channel; the second segment of the second convex rib, the second segment of the fourth convex rib and the bracket holder are combined to form the transition segment of the third guide channel.

22. The busbar fixing assembly according to claim 19, wherein a side of the first top wall facing the first convex rib, a side of the first convex rib facing the first top wall, a side of the first convex rib facing the second convex rib, a side of the second convex rib facing the first convex rib, a side of the second top wall facing the third convex rib, a side of the third convex rib facing the second top wall, a side of the third convex rib facing the fourth convex rib, and a side of the fourth convex rib facing the third convex rib are all provided with a reinforcing rib.

23. The busbar fixing assembly according to claim 11, wherein along the third direction, the auxiliary fixing member further comprises a first connecting seat and a second connecting seat, the first connecting seat is arranged on a side of the first part away from the second part, the second connecting seat is arranged on a side of the second part away from the first part, and the first connecting seat is provided with a first connecting hole, and the second connecting seat is provided with a second connecting hole;
both sides of the bracket holder is respectively provided with a first fixing seat and a second fixing seat along the third direction, the first fixing seat is provided with a first fixing hole, and the second fixing seat is provided with a second fixing hole; and
the first fixing hole is detachably connected with the first connecting hole, and the second fixing hole is detachably connected with the second connecting hole.

24. The busbar fixing assembly according to claim 23, wherein the first connecting seat is further provided with a plurality of first bumpers, the first fixing seat is provided with a plurality of first matching grooves, the plurality of first bumpers correspond to the plurality of first matching grooves one to one, and the first bumpers are inserted in corresponding first matching grooves;
the second connecting seat is further provided with a plurality of second bumpers, the second fixing seat is provided with a plurality of second matching grooves, the plurality of second bumpers correspond to the plurality of second matching grooves one to one, and the second bumpers are inserted in corresponding second matching grooves.
